(19) United States
(12) Patent Application Publication
(10) Pub. No.: US 2026/0071759 A1
(43) Pub. Date: Mar. 12, 2026

(54) NONSTICK THREE-DIMENSIONAL OVEN LINER INSERT

(71) Applicant: AFC PACKAGING L.L.C., LAKE IN THE HILLS, IL (US)

(72) Inventors: William James LEWIS, Naples, FL (US); William Christopher LEWIS, St. Charles, IL (US); Barton Roy LEWIS, Algonquin, IL (US); Barton R. LEWIS, Jr., Algonquin, IL (US)

(73) Assignee: AFC PACKAGING L.L.C., LAKE IN THE HILLS, IL (US)

(21) Appl. No.: 19/107,717

(22) PCT Filed: Sep. 1, 2023
(86) PCT No.: PCT/US2023/031862

§ 371 Date: Feb. 28, 2025

Related U.S. Application Data
(60) Provisional application No. 63/403,086, filed on Sep. 1, 2022.

(51) Int. Cl. F24C 15/08; F24C 15/00; F24C 15/12; F24C 15/16

(52) U.S. Cl. CPC F24C 15/08; F24C 15/007; F24C 15/12; F24C 15/16

(57) ABSTRACT

An oven liner for placement in an oven cavity during cooking. The oven liner includes nonstick sections corresponding to the top, bottom and/or sides of the oven cavity. The liner is made including a nonstick material, and is easily removable for cleaning. Liner sections can be attached by clips within the oven cavity. Liner sections can be connected to each other by a material hinge, such as with a bottom section corresponding to an oven bottom, and at least one side section extending from the bottom section and corresponding to an oven side wall.

### FIELD OF THE INVENTION

This invention is directed to heat resistant polymer materials and product uses thereof, and more particularly to an oven liner for placement in an oven to protect the oven cavity and otherwise improve cleaning of the oven cavity.

### SUMMARY OF THE INVENTION

A general object of the invention is to provide an improved liner insert for lining/covering oven cavity surfaces and/or heating elements. The invention provides a rigid, easily cleanable, fast heat dissipating, microwave transparent alternative to traditional metallic oven structural components. The liner insert is rigid enough to protect as many oven parts as necessary. When dirty, the liner insert is designed to be removed, cleaned (rinsed and wiped), and reinstalled.

One object of the invention is to provide an improved nonstick material and products thereof, such as an oven liner, particularly for use in high speed, rapid cook, and/or conventional ovens. Embodiments of the invention provide for easy placement in and removal from ovens, cover at least one, desirably two, and more desirably multiple surfaces in the oven (bottom, sides, oven racks, etc.), cool down quickly and do not hold heat (e.g., mostly or fully free of metal), and can withstand temperatures over 375° F. (191° C.) for an indefinite period of time, and more preferably up to and over 500° F. (260° C.). In embodiments, all components, including any attachment fasters/connectors are made from the same materials and also free of metal.

Another general object of the invention is to provide a nonstick, reusable oven liner including at least a polymer surface. The liner layers and/or surfaces can be formed of a ‘nonstick’ polymer, contain a non-stick additive as part of the polymer matrix, dip or spray coated with a nonstick polymer, and/or be covered with a removable nonstick polymer surface insert. Various polymers are available for these applications.

Exemplary nonstick surface polymer materials according to embodiments of this invention include melt-processible fluoropolymers, such as perfluoroalkoxy alkanes (PFA), TFE/perfluoromethylvinylether copolymer (MFA), or fluorinated ethylene propylene (FEP). Additionally blends of fluoropolymers, such as MFA, PFA, FEP, ECTFE, and PTFE, as well as non-stick, silicone-containing materials can also be utilized.

Embodiments of this invention include an improved woven/polymer/nonstick laminate material with structural benefits, and that is pressable or otherwise moldable in a forming method to provide a shaped oven liner. Exemplary polymers for these embodiments include engineered resins. These are resins typically blended with fluoropolymer and or silicone. The engineered resins are used for barrier or abrasion, not structure, as fluoropolymer or silicone incorporation generally prevents structural use of engineered resin. The material composite of this invention can incorporate 100% engineered resin until the woven glass substrate is sufficiently saturated such that, when molded, the engineered resin is consolidated to create a structural component. Another feature is that the invention bonds a nonstick material, such as a fluoropolymer or silicone to the 100% engineered resin. This provides good bond strength.

All embodiments of this invention can include or be formed of composite material layers, including a flexible substrate impregnated with a heat resistant polymer material and coated with a nonstick coating, wherein the composite material has a structural rigidity when cured. The composite material is pressable or moldable into a predetermined configuration before or during curing and holds the predetermined configuration with the structural rigidity when cured. One preferred predetermined configuration is an oven liner with a bottom and perpendicular wings for oven side wall coverage, or a flat oven liner with foldable wings for placement in the oven. Surface undulations in the oven can be matched and pressed into the liner during manufacture. Further embodiments of the invention include a back and/or top wall coverings, which can be integrally attached to the bottom and/or sides, or separately attachable.

Embodiments of this invention include surface coatings, such as applied by spray or dip coating, or as a film or coated fabric. In additional embodiments of this invention, the surface is first dip or spray coated and then covered/laminated with a casted or laminate film, or coated fabric, of one or more of, for example: silicone materials and/or fluoropolymers, such as melt-processible fluoropolymers or blends of PTFE and melt-processible fluoropolymers. The spray coating and casted film, etc. desirably interlock together during curing, providing stronger bonding to the underlying cookware surface.

The invention includes an oven liner for placement in an oven cavity during cooking, the oven liner including at least one side section corresponding to an oven side wall.

In embodiments of this invention, the liner further includes a bottom section corresponding to an oven bottom, and the at least one side section extends from the bottom section.

Embodiments of this invention include a multi-layer, tri-fold oven liner/cavity insert. The insert is made from multiple individual laminate layers, such as of a coated/impregnated flexible material. The individual layers are pressed under heat to form a final rigid, laminate liner.

The invention further includes an oven liner or insert for placement in an oven cavity during cooking. The oven liner or insert includes a bottom section corresponding to an oven bottom, and at least one side section extending from the bottom section and corresponding to an oven side wall. Preferably, the liner includes two side sections, each on an opposite side of the bottom section. The side sections are desirably connected to the bottom section by a fold line hinge, such as formed of weaknesses/perforations or a reduced laminate/layer thickness. In embodiments, the reduced thickness is formed by breaks or spacings (e.g., channels) in various laminate layers, such as in one or more layers below a nonstick top layer.

In embodiments, individual panels are held in the oven by one or more connectors. The connectors include or form a channel for receiving and securing an edge of the liner panels. The connectors can be a single, longer channel for each edge or a plurality of clips. The connectors are also preferably made from the heat resistant and/or nonstick materials disclosed for the liner.

The oven liner of this invention is desirably durable for multiple heating cycles, high temperature and water resistant, easy to clean, stain resistant, and dissipates heat quickly; all while desirably not having any or much effect on the cooking of food. The oven can include a solid bottom section, such as to prevent liquids from dripping on heating elements, or a perforated bottom or side to allow better heat/air flow.

Other objects and advantages will be apparent to those skilled in the art from the following detailed description taken in conjunction with the appended claims and drawings.

### BRIEF DESCRIPTION OF THE DRAWINGS

FIGS. 1-4 show an oven cavity liner insert according to one embodiment of this invention.

FIGS. 5-8 show an oven cavity liner insert according to one embodiment of this invention, in combination with an example oven.

FIGS. 9-11 show an oven cavity liner insert according to one embodiment of this invention.

FIGS. 12-14 show an oven cavity liner insert according to one embodiment of this invention, in combination with an example oven.

### DETAILED DESCRIPTION OF THE INVENTION

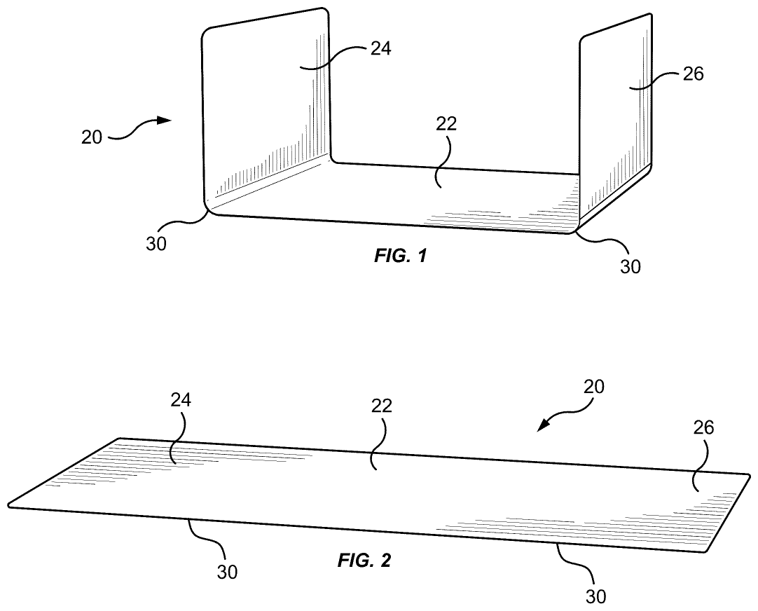

FIGS. 1-4 show a multi-layer, tri-fold oven liner/cavity insert 20 (hereinafter “oven liner”), according to an exemplary embodiment of this invention. The oven liner 20 provides for improved cleaning, as well as reducing potential arcing in the oven cavity of an electric oven. Liners of embodiments of this invention can cover or replace metallic bottom impingement plates, which have potential arcing issues, particularly during food splattering occurrences. The oven liner or cavity insert is designed to be easily installed and removed so that it can be quickly rinsed and wiped as needed and go right back to cooking. The construction and materials used in the present invention minimize downtime and potential burn hazards when compared to traditional cleaning methods.

FIG. 1 shows the oven liner 20 in a folded position for oven insertion and use. The oven liner 20 includes a bottom 22, corresponding to an oven bottom, and two upwardly extending sides 24, 26, corresponding to oven cavity side walls. FIG. 2 shows the oven liner in a pre-folded, planar configuration, such as for improved shipping and storage.

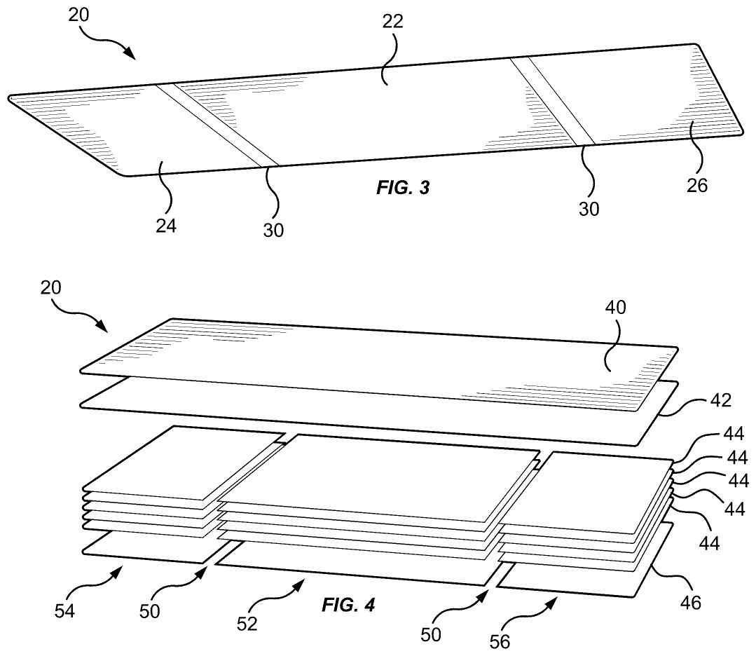

In embodiments of this invention, the oven liner 20 includes fold lines 30 between the bottom 22 and each side 24, 26. The fold lines 30 can be a weakened line in the substrate, such as a perforated line, or a line of reduced thickness, such as shown better in FIGS. 3 and 4.

FIG. 4 shows an exploded view of a layered construction, according to one embodiment of this invention. FIG. 4 shows a top nonstick layer 40, extending a full length of the oven liner 20. A second full length support layer 42 is added below the top layer 40. The remaining layers of the laminate oven liner include 5 intermediate layers 44, and a bottom layer 46. In the illustrated embodiment, the fold lines 30 are formed by separation spaces 50 between intermediate layer sections and the bottom layer sections. In other words, each of the intermediate layers 44 and the bottom layer 46 are formed of three sections 52 (corresponding to the bottom 22), 54 (corresponding to the side 24), and 56 (corresponding to the side 36). The result is a thinner laminate thickness in the fold lines 30, such that the support layer 42 is exposed from the bottom within the spaces 50 (see FIG. 3).

The oven liners of this invention, and preferably each laminate layer, are high temperature (≥375° F.) resistant. For each layer, a composite can be formed by impregnating and/or coating one or more selected flexible substrates with a selected polymer material. Exemplary flexible substrates suitable for the laminate layers include woven substrates, non-woven substrates, open mesh/leno weave substrates, braided substrates, and/or unidirectional fabrics, such as made using fiberglass or other suitable fibrous materials, such as Kevlar, Nomex, carbon fiber, quartz fiber, PEEK, PAEK, PPS, PES, PPSU, LCP, and/or PAI fibers, or combinations of such fibers or yarns. Exemplary polymer materials include melt-processible fluoropolymers, preferably a perfluoroalkoxy alkane (PFA), TFE/perfluoromethylvinylether copolymer (MFA), or fluorinated ethylene propylene (FEP), homopolymer or copolymers of PTFE, or combinations of such fluoropolymers, and/or engineered thermoplastic materials and blends thereof. The engineered thermoplastic desirably acts as a support and structure for the composite once molded.

According to some embodiments of this invention, the forming process begins with a substrate, such as a woven fiberglass substrate, which can include plies of coated linear strand fiberglass. The substrate is saturation coated with a solution of dissolved or suspended polymer, such as PAI, PPS, PEEK, PPSU, PES, or combinations thereof, or other suitable plastics known for high temperature use. Multi-pass applications of the coating can be used to adequately saturate the fibers, and build adequate weight for flow and forming. The polymer coated substrate is preferably dried and prepared to a pre-preg (pre-impregnated) condition. For at least the outer layers, a topcoat of PTFE or other nonstick material is applied to one or both sides. The fluoropolymer coating provides mold release functionalities during forming, and provides a high performance release finish for use (similar to cookware coatings). The coating can be applied by, for example, a heavily coated single ply coating and/or multi-ply lamination of lighter weight woven or linear strand fiberglass.

In embodiments, more than one, and desirably all, substrate layers can be impregnated. In addition, more than one separately impregnated substrate can be laminated together prior to top coating. The multiple layers can be the same or different substrate materials, such as, for example, a coated woven can be laminated to a coated nonwoven on one or both sides. The type and number of layers can be adjusted for rigidity, depending on need.

As an example, without limitation, in the illustrated embodiment of FIG. 4, each of the top layer 40, the support layer 42, the intermediate layers 44 and the bottom layer 46 are different material constructions. The top layer 40 is a fluoropolymer coated/impregnated fiberglass material of 10 mils. The support layer 42 is a fluoropolymer coated/impregnated fiberglass material of 8 mils. Each intermediary layer 44 is a fluoropolymer coated/impregnated fiberglass material of 6 mils. The bottom layer 46 is a fluoropolymer coated/impregnated fiberglass material of 6 mils. The top layer 40 and support layer 42 are separately laminated together with heat and pressure. The remaining six layers are also laminated together, in the individual sections 52, 54, 56, and then the four intermediate laminates are fixed into place and laminated together for the final oven liner 20. Die cutting of the various shapes can be done during the intermediate laminating and/or after the final laminating.

As will be appreciated, various sizes, shapes, and configurations are available for the oven liner, the individual sections or laminate layers, fold lines, etc., depending on need. The bottom and side sections can be shaped to cover the full corresponding oven surfaces, or only a portion thereof. A third upwardly extending back section can also be included. Various openings, such as for air flow or oven components (e.g., shelf brackets, lights, heating/microwave elements, convection elements, etc.) can be die cut in the oven liner, depending on need.

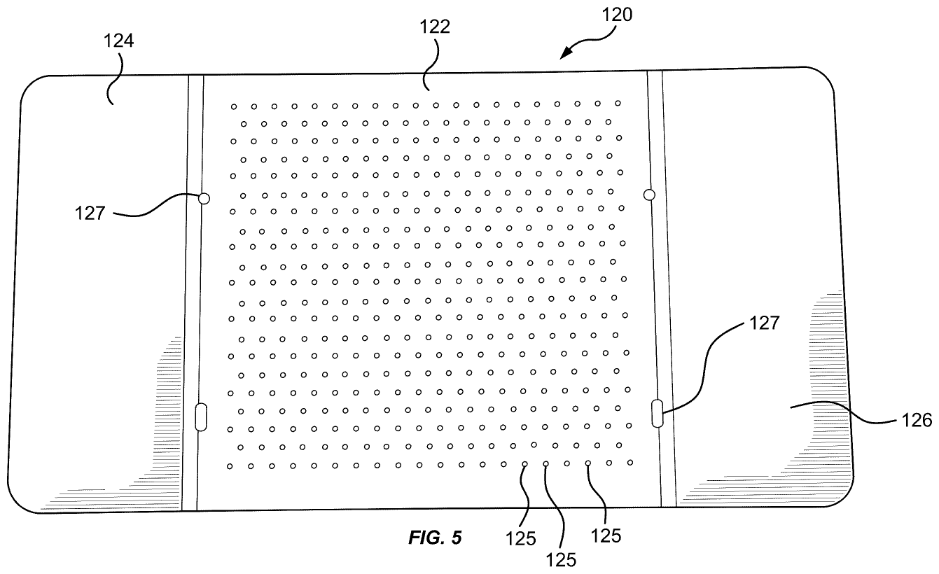

FIGS. 5-8 show an oven liner 120 according to one embodiment of this invention. The oven liner 120 includes a bottom 122, and two sides 124, 126, similar to FIGS. 1-4. Fold line hinges 130 are disposed along and between the bottom 122 and each of the sides 124, 126. The bottom 122 includes a plurality of die-cut, perforated openings 125, such as to allow more efficient heated air flow. Openings 127 in the hinge area 130 allow for existing oven element fitment.

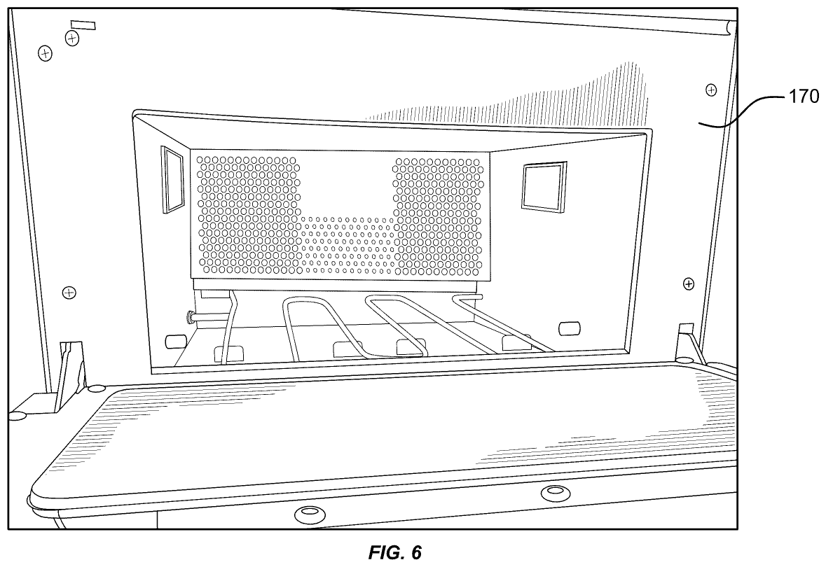

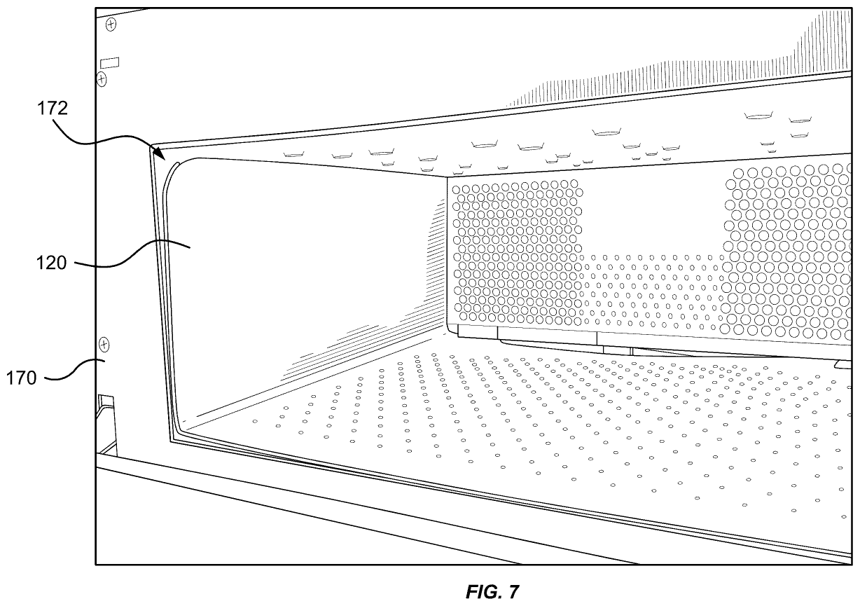

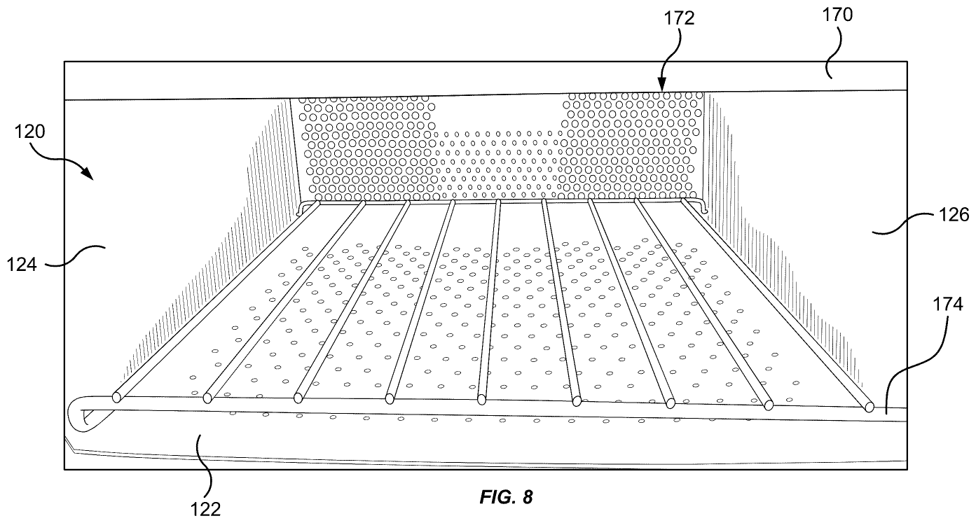

FIG. 6 shows an exemplary oven 170. FIG. 7 shows the oven liner 120 fitted within the oven cavity 172. FIG. 8 shows an oven rack 174 placed in the oven cavity 172 and on the oven liner 120. The oven liners or cavity inserts can be customized to fit any oven cavity as well as any other mating components necessary for proper oven function.

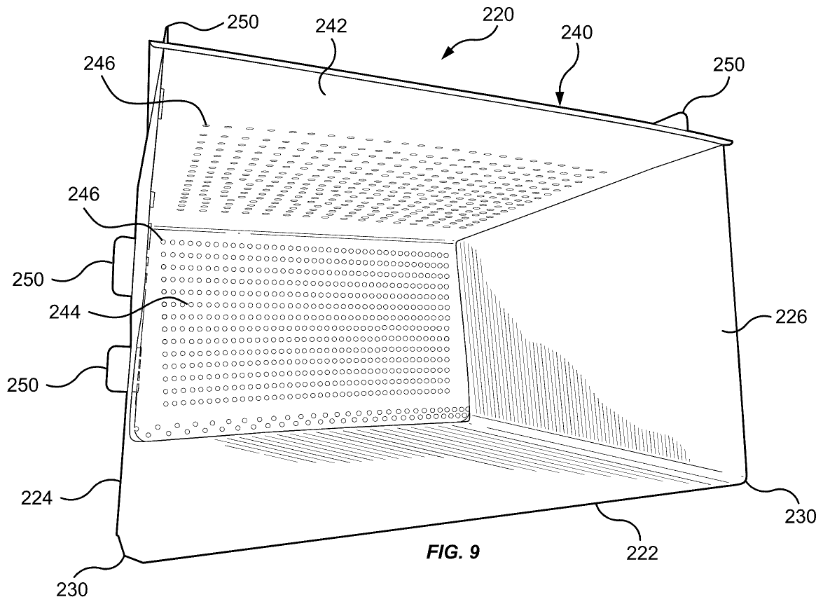

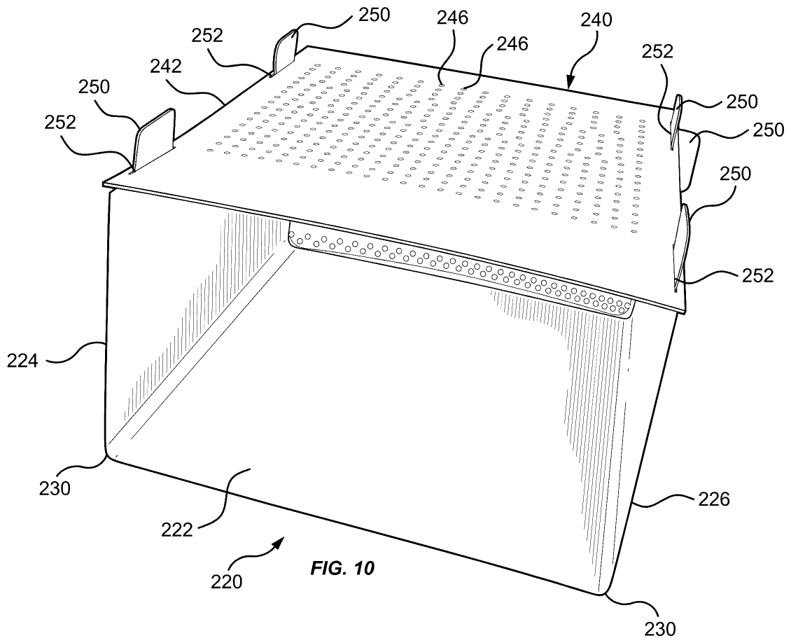

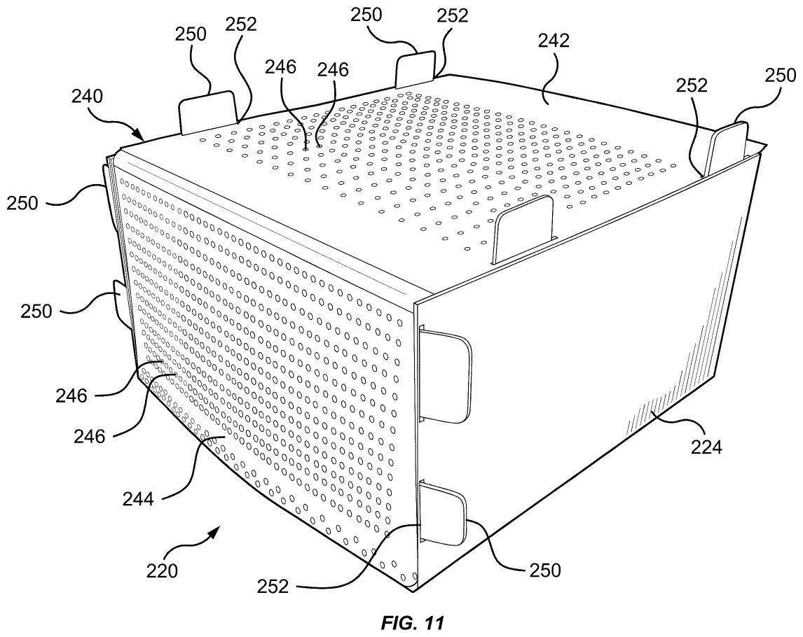

FIGS. 9-11 illustrate a further embodiment of an oven liner 220. The oven liner 220 includes a bottom wall 222, corresponding to an oven bottom, and two upwardly extending sides 224, 226, corresponding to oven cavity side walls. The oven liner further includes a top wall 242 and rear wall 244, corresponding to oven cavity top and back walls respectively. The top wall 242 and the rear wall 244 each includes openings 246 to allow heated air therethrough, desirably corresponding to oven components. Fold lines 230 connect the bottom 222 and each side 224, 226.

In the illustrated embodiment the top wall 242 and rear wall 244 are configured as a separate component 240 attached to the side walls 224, 226 by tabs 250 of one component fitting into slits 252 of an adjacent component. As illustrated tabs 250 extend upward from the side wall 224, 226 and fit into slits 252 in the top wall 242. The rear wall 244 includes tabs 250 that extend laterally into slits 252 in the side wall 224, 226. Various and alternative connections can be used to make the connections of the various numbers and configurations of the liner walls, such as heat resistant ‘tape’or fasteners.

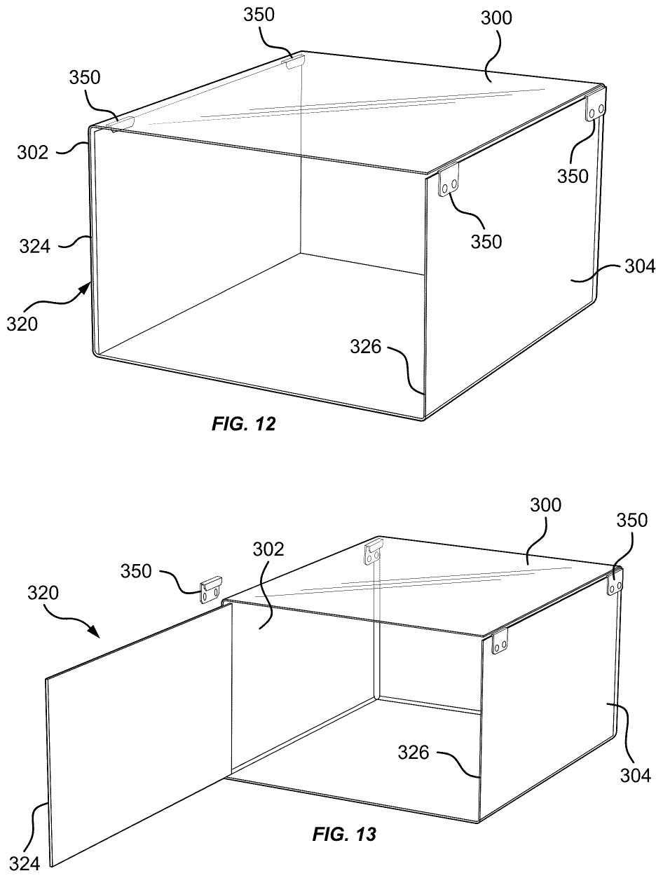

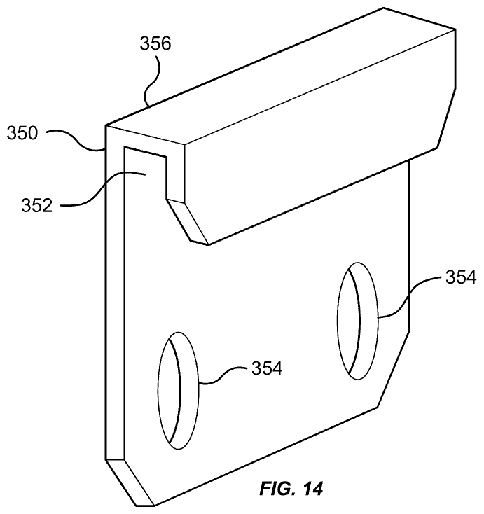

FIGS. 12-14 illustrate a further embodiment of an oven liner 320 for oven cavity 300. The oven liner 320 as illustrated includes two upwardly extending side walls 324, 326 corresponding to oven cavity side walls 302 and 304. The side walls 324, 326 are each individual panels which can separately be removed for cleaning, as shown in partially exploded FIG. 13. The oven liner 320 can also include removeable bottom, top, and/or back wall panels corresponding to an oven bottom, top, and/or back wall, depending on need. The panels can be made from any materials and configuration (e.g., layers) described herein.

The side walls 324 and 326 are each held in place by one or more, preferably at least two, connectors 350. The connectors 350 can be any suitable component that allows for sliding out a panel as shown in FIG. 13, such as a channel rail or clip with one or more, preferably U-shaped, channels for securing an edge 328 of the panel 324. As shown in FIGS. 12 and 13, the connectors 350 are clips that can be attached to the oven walls 302 or 304, such as by drilling and tapping. FIG. 14 shows an exemplary clip connector 350, with panel channel 352, and tapping holes 354. As an alternative, a support structure such as a box frame surround corresponding to the oven cavity can be used to attach the connectors, or the frame can have integrally formed channels. In addition, a top liner panel can sit on a top surface 356 of the connectors, and/or a rear and/or bottom liner panel can be held in place by the rear or bottom edges of the side panels. Alternatively, the bottom panel can be inserted between the side panels for securing the side panels bottoms edges against the oven sides. Lower connectors can also be used. The connectors can also be used to secure side panels of other embodiments, such as the tr-fold liner in FIG. 1.

The connectors 350 can be any suitable connector made from any suitable material. In presently preferred embodiments, the connector, and any optional support frame, is an extruded glass-filled connector. The extrusion material can be any heat-resistant material discussed herein, and is desirably a PTFE material such as disclosed above.

Thus the invention provides an oven liner or cavity insert formed of a laminate composite material that is formable by heated press or other stamp/press molding. The oven liner has a folded, three dimensional configuration to provide better, full coverage of surfaces of the oven cavity. The insert is non-stick and easily removable/replaceable for easy cleaning.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

1. An oven liner for placement in an oven cavity during cooking, the oven liner including at least one side section corresponding to an oven side wall.

2. The oven liner of claim 1, further comprising a bottom section corresponding to an oven bottom, and the at least one side section extending from the bottom section.

3. The oven liner of claim 2, further comprising a tri-fold oven liner/cavity insert.

4. The oven liner of claim 3 further comprising two side sections, each on an opposite side of the bottom section.

5. The oven liner of claim 2, wherein the at least one side section is connected to the bottom section by a fold line hinge.

6. The oven liner of claim 5, wherein the fold line hinge comprises a reduced thickness.

7. The oven liner of claim 6, wherein the reduced thickness comprises spaces in laminate layers below a top layer.

8. The oven liner of claim 1, further comprising a connector for securing the side section to the oven side wall, the connector including or forming a channel for receiving and securing an edge of the side section.

9. The oven liner of claim 1, claims, wherein the oven liner is a pressed and/or molded laminate of a plurality of polymer coated and/or impregnated flexible substrates.

10. The oven liner of claim 9, wherein at least a top layer comprises a top surface of a nonstick polymer.

11. The oven liner of claim 9, comprising a flexible substrate of a woven substrate, non-woven substrate, open mesh/leno weave substrate, braided substrate, and/or unidirectional fabrics, formed of fiberglass, Kevlar, Nomex, carbon fiber, quartz fiber, PEEK, PAEK, PPS, PES, PPSU, LCP, and/or PAI fibers, or combinations of such fibers or yarns.

12. The oven liner of claim 11, comprising a heat resistant polymer material of a melt-processible fluoropolymer, preferably a perfluoroalkoxy alkane (PFA), TFE/perfluoromethylvinylether copolymer (MFA), or fluorinated ethylene propylene (FEP), homopolymer or copolymers of PTFE, or combinations of such fluoropolymers.

13. Use of the oven liner in an oven according to claim 1.

14. The use according to claim 13, further comprising removing, cleaning, and replacing the oven liner.

15. A method comprising providing a removable and replaceable oven liner according to claim 1, which is separate from and adapted to be removably secured within an oven, and removing, cleaning, and replacing the oven liner insert in an oven cavity.

16. The oven liner of claim 2, further comprising a connector for securing the side section to the oven side wall, the connector including or forming a channel for receiving and securing an edge of the side section.

17. An oven liner for placement in an oven cavity during cooking, the oven liner comprising:
a bottom section corresponding to an oven bottom; and
at least one side section extending from the bottom section and corresponding to an oven side wall.

18. The oven liner of claim 17 further comprising two side sections, each on an opposite side of the bottom section.

19. The oven liner of claim 17, further comprising a connector for securing a top edge of the side section to the oven side wall, the connector including or forming a channel for receiving and securing the top edge of the side section.

20. The oven liner of claim 17, wherein each of the bottom section and the at least one side section is a pressed and/or molded laminate of a plurality of polymer coated and/or impregnated flexible substrates.
